(19) United States
(12) Patent Application Publication
(10) Pub. No.: US 2023/0150012 A1
(43) Pub. Date: May 18, 2023

(54) Fencing Wire Crimper Tool

(71) Applicant: Bradley Ritter, Carthage, NC (US)

(72) Inventor: Bradley Ritter, Carthage, NC (US)

(21) Appl. No.: 17/529,039

(22) Filed: Nov. 17, 2021

(51) Int. Cl. B21F 15/06; B25B 27/14

(52) U.S. Cl. CPC B21F 15/06; B25B 27/146; E04H 17/268

(57) ABSTRACT

An article of manufacture for providing an easy wire-crimping tool according to the present invention includes a wire-crimping tool according to the present invention for accepting a crimping sleeve having two or more wire members within the crimping sleeve to crimp the crimping sleeve and the two or more wire members together. The wire-crimping tool has a crimping tool body having one or more lower crimping teeth, a crimping tool head having one or more upper crimping teeth configured to interlock between the lower crimping teeth to create one or more pinch point crimps into the crimping sleeve, and a crimping power source coupled to the crimping tool body and to the crimping tool head to cause the upper and lower crimping teeth to move together when a crimping sleeve is in between.

### TECHNICAL FIELD

This application relates in general to an article of manufacture for providing a fence-building device, and more specifically, to an article of manufacture providing an easy wire-crimping tool.

### BACKGROUND

A crimping sleeve is known to be used to couple two or more wire elements together to construct items that typically are used in the agriculture industry for items such as woven and electric wire fencing, and similar mesh structures used to restrain cattle, goats, horses, deer, canine, and related domesticated animals. To construct these woven items, a person uses a hand-crimping tool to individually create multiple crimps in the sleeves. Each crimp requires a user to apply force to a crimping tool to couple wires within the sleeves. This activity is strenuous and tiring, and requires a lot of time and effort from a user to complete a small task. These tasks typically are repeated many times by users as useful items are made, installed, and repaired.

Therefore, a need exists for an article of manufacture for providing an easy wire-crimping tool. The present invention attempts to address the limitations and deficiencies in prior solutions according to the principles and example embodiments disclosed herein.

### SUMMARY

In accordance with the present invention, the above and other problems are solved by providing an article of manufacture for an easy wire-crimping tool according to the principles and example embodiments disclosed herein.

In one embodiment, the present invention is an article of manufacture for providing an easy wire-crimping tool. The wire-crimping tool according to the present invention accepts a crimping sleeve having two or more wire members within the crimping sleeve to crimp the crimping sleeve and the two or more wire members together. The wire-crimping tool includes a crimping tool body having one or more lower crimping teeth, a crimping tool head having one or more upper crimping teeth configured to interlock between the lower crimping teeth to create one or more pinch point crimps into the crimping sleeve, and a crimping power source coupled to the crimping tool body and to the crimping tool head to cause the upper and lower crimping teeth to move together when a crimping sleeve is in between.

According to another aspect of the present invention, the wire-crimping tool further includes a crimping tool threaded shaft coupled to the crimping tool head, the crimping tool threaded shaft having threads about a lower end that extends out of the crimping tool body, and a crimping tool nut having matching threads to the crimping tool threaded shaft and being configured to cause the crimping tool threaded shaft to move through the crimping tool nut when rotated. The movement of the crimping tool shaft out of the crimping tool body and through the crimping tool nut causes the crimping tool head and the corresponding upper crimping teeth to move towards the crimping tool body and corresponding lower crimping tool teeth.

According to another aspect of the present invention, the crimping tool nut mates to a socket wrench coupled to a power tool, the power tool reversibly rotates to open and close the space between the crimping tool head with the corresponding upper crimping teeth and the crimping tool body with the corresponding lower crimping tool teeth, and the crimping power source powering the power tool.

According to another aspect of the present invention, the power tool is a drill/impact wrench.

According to another aspect of the present invention, the power tool is a power screwdriver.

According to another aspect of the present invention, the crimping power source is a rechargeable battery coupled to the power tool.

According to another aspect of the present invention, the crimping power source is a power cord coupled to the power tool for connecting the power tool to an AC power source.

According to another aspect of the present invention, the upper crimping teeth and the lower crimping teeth create a single pinch point crimp in the crimping sleeve.

According to another aspect of the present invention, the upper crimping teeth and the lower crimping teeth create two or more pinch point crimp in the crimping sleeve.

According to another aspect of the present invention, the crimping power source is a hydraulic power source.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment of an article of manufacture providing an easy wire-crimping tool according to the present invention.

FIGS. 2a-b illustrate additional views of an article of manufacture providing an easy wire-crimping tool according to the present invention.

FIG. 3 illustrates an article of manufacture providing an easy wire-crimping tool in use with a power tool according to the present invention.

FIG. 4 illustrates a wire-crimping sleeve for use with the article of manufacture providing an easy wire-crimping tool according to the present invention.

FIG. 5 illustrates a wire-crimping sleeve coupling two wire lines together made using an article of manufacture providing an easy wire-crimping tool according to the present invention.

FIG. 6 illustrates a woven wire mesh made using an article of manufacture providing an easy wire-crimping tool according to the present invention.

### DETAILED DESCRIPTION

This application relates in general to an article of manufacture for providing a wire fence-building device, and more specifically, to an article of manufacture providing an easy wire-crimping tool according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The terms “individual” and “user” refer to an entity, e.g., a human, using an article of manufacture providing an easy wire-crimping tool according to the present invention. The term user herein refers to one or more users.

The term “invention” or “present invention” refers to the invention being applied for via the patent application with the title “Fencing Wire Crimper Tool.” Invention may be used interchangeably with crimper.

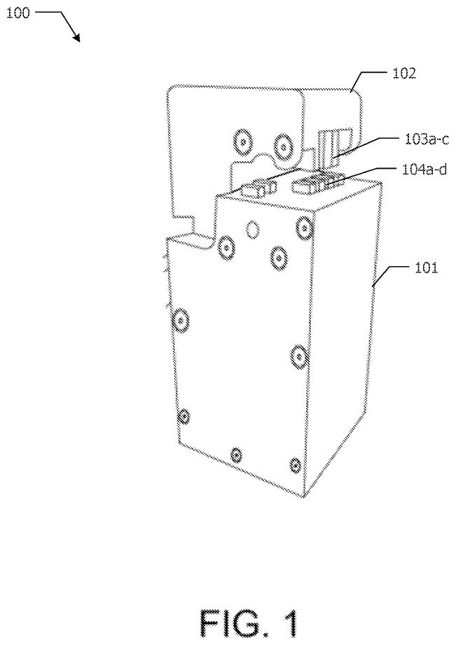

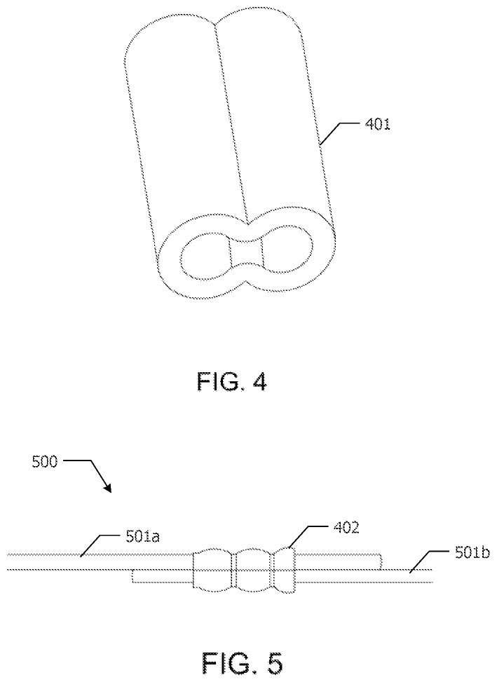

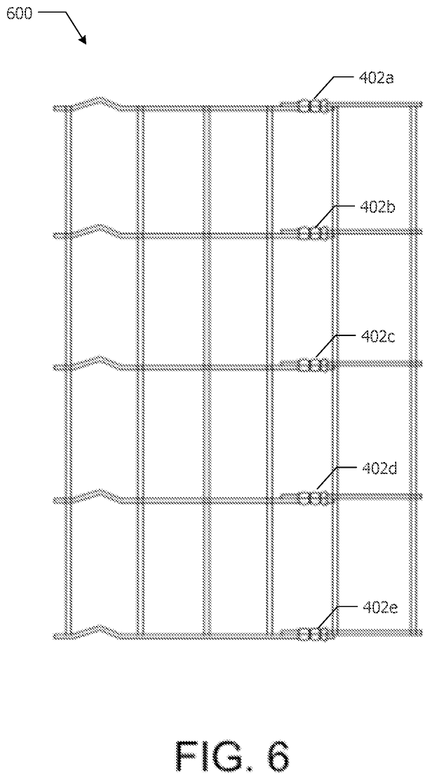

In general, the present disclosure relates to an article of manufacture providing an easy wire-crimping tool according to the present invention. To better understand the present invention, FIG. 1 illustrates an example embodiment of an article of manufacture providing an easy wire-crimping tool 100 according to the present invention. The wire crimping tool 100 may be used to crimp a crimping sleeve 401 as shown in FIG. 4 to couple two or more joined wires 501a-b as shown in FIG. 5 and to construct a wire mesh 600 as shown in FIG. 6.

The wire-crimping tool 100 comprises a crimping tool body 101, a crimping tool head 102, a set of upper crimping tool teeth 103a-c, a set of lower crimping tool teeth 104a-d, and crimping tool nut 201. The crimping tool body 101 and crimping tool head 102 are configured to create a space between which the upper crimping tool teeth 103a-c and the lower crimping tool teeth 104a-d are arranged such that a crimping sleeve 401 may be positioned in between the sets of crimping tool teeth 103-104. When the crimping tool nut 201 rotates, the crimping tool head 102 is pulled toward the crimping tool body 101 causing the upper crimping tool teeth 103a-c and the lower crimping tool teeth 104a-d to apply pressure upon a crimping sleeve 401 in between to create multiple crimps in the crimping sleeve 401. When joined wires 501a-b are inserted into the crimping sleeve 401 before the crimping tool nut 201 is rotated, the creation of the crimps will couple the joined wires 501a-b between the crimped part of the crimping sleeve 401.

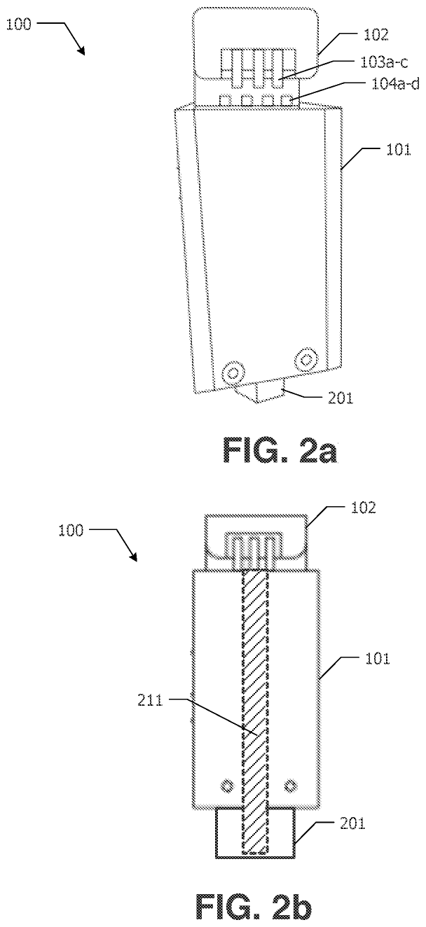

FIGS. 2a-b illustrate additional views of an article of manufacture providing an easy wire-crimping tool according to the present invention. FIG. 2a shows a front view of a wire-crimping tool 100 with the crimping tool nut 201 shown on the opposite end of the crimping tool body 101 from the crimping tool head 102. The upper crimping tool teeth 103a-c and the lower crimping tool teeth 104a-d are shown arranged to move between each other when the crimping tool head 102 is pulled toward the crimping tool body 101. A crimping sleeve 401 is pinched in between these upper crimping tool teeth 103a-c and lower crimping tool teeth 104a-d when the crimping tool head 102 moves toward the crimping tool body 101. Once the crimps are completed, the crimping tool head 102 may be repositioned apart from the crimping tool body 101, thus allowing the upper crimping tool teeth 103a-c and the lower crimping tool teeth 104a-d to once again separate. The crimped sleeve 402 may be removed once the crimping tool head 102 and crimping tool body 101 have separated.

While the embodiment of FIG. 2a is shown having multiple interlocking teeth to create multiple teeth in the crimping sleeve 401, other embodiments are possible that create one long crimp along the length of the crimped sleeve 402. In addition, the crimping tool body 101 and the crimping tool head 102 also may be sized to accept different sized crimping sleeves 401. The size of the crimping sleeve 401 would define the size of the space needed between the crimping tool body 101 and the crimping tool head 102 when the tool is in an open position.

FIG. 2b shows a functional diagram of the wire crimping tool 100. The crimping tool body 101 and the crimping tool head 102 are shown in a closed position with the upper crimping tool teeth 103a-c and the lower crimping tool teeth 104a-d engaging each other. A crimping tool threaded shaft 211 is shown running through the crimping tool body 101 from the crimping tool head 102. The crimping tool threaded shaft 211 engages with threads within the crimping tool nut 201 such that when the crimping tool nut 201 rotates the crimping tool threaded shaft 211 is moved in the direction of the rotation of the crimping tool nut 201. As the upper end of the crimping tool threaded shaft 211 is physically coupled to the crimping tool head 102, the rotation of the crimping tool nut 201 and corresponding movement of the crimping tool threaded shaft 211 causes the crimping tool head 102 to move upward and downward.

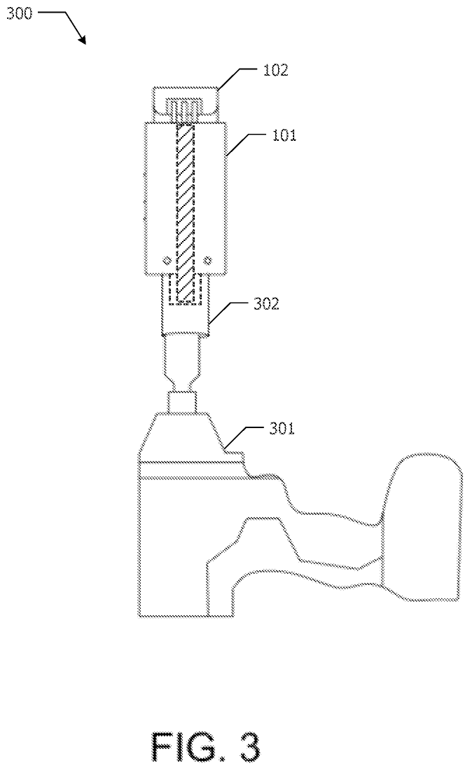

FIG. 3 illustrates an article of manufacture providing an easy wire-crimping tool in use with a power tool according to the present invention. The wire crimping tool 300 and drill/impact wrench 301 combination allows a socket wrench 302 coupled to the shaft of the drill/impact wrench 301 to rotate the crimping tool nut 201 using the force exerted by the drill/impact wrench 301. As such, the crimping tool head 102 is pulled to the crimping tool body 101 causing the upper crimping tool teeth 103a-c and lower crimping tool teeth 104a-d to crimp a crimping sleeve 401 in between using the force generated by the drill/impact wrench 301. The drill/impact wrench 301 may operate in either direction as needed to close and open the wire crimping tool 100.

A user may crimp wires together as shown in FIG. 5 by inserting the joined wires 501a-b into the crimping sleeve 401 and placing the crimping sleeve 401 between the upper crimping tool teeth 103a-c and lower crimping tool teeth 104a-d. Once in place, the user may engage the drill/impact wrench 301 to close the crimping tool head 102 toward the crimping tool body 101 creating a set of pinch point crimps in the crimping sleeve 401. Once crimped, the user may use the drill/impact wrench 301 to separate the upper crimping tool teeth 103a-c once again from the lower crimping tool teeth 104a-d allowing the crimped sleeve 402 to be removed from the wire crimping tool 100.

While the embodiment of FIG. 3 shows the wire crimping tool 300 is shown using the drill/impact wrench 301 to rotate the crimping tool nut 201 that operates the wire crimping tool 300, one of ordinary skill in the art will recognize that other power tools may be used in a similar way. For example, a power screwdriver that accepts a connecting drive shaft to match the socket wrench 302 may be used. Additionally, the power tools 301 may be battery powered as well as electrically powered by an extension cord. The power tool 301 needs to be able to provide power rotation to the crimping tool nut 201 in both directions while under the control of a user. The power tool 301 also must be capable of exerting sufficient torque to the crimping tool nut 201 to press the crimping tool body 101 and the crimping tool head 102 together as well as apply pressure to the crimping sleeve 401 to create the pinch points in the crimping sleeve 401. The power tool 301 and its battery (not shown) also may be integrated into a single device in which the reversible motor of the power tool 301 is directly coupled to the crimping tool threaded shaft 211.

For larger crimping sleeves that require a large amount of force to create the one or more pinch points, additional force to press the crimping tool body 101 and the crimping tool head 102 together may be supplied by other crimping power sources. For example, a hydraulic line may be used to create the force onto the crimping tool head 102 causing it to press into the crimping tool body 101. The crimping tool body 101 and the crimping tool head 102 would automatically separate when the hydraulic force is removed using a compression spring (not shown) or similar device.

FIG. 4 illustrates a wire crimping sleeve for use with the article of manufacture providing an easy wire-crimping tool according to the present invention. A standard crimping sleeve 401 is shown having a pair of interconnected cylindrical tubes joined together lengthwise. The joined wires 501a-b are inserted into the interconnected cylindrical tubes of the crimping sleeve 401 and interconnected cylindrical tubes are pressed together by the wire crimping tool 100 to crimp the joined wires 501a-b within the crimping sleeve 401.

FIG. 5 illustrates a wire crimping sleeve coupling two wire lines together made using an article of manufacture providing an easy wire-crimping tool according to the present invention. Similarly, FIG. 6 illustrates a woven wire mesh made using an article of manufacture providing an easy wire-crimping tool according to the present invention.

Even though particular combinations of features are recited in the present application, these combinations are not intended to limit the disclosure of the invention. In fact, many of these features may be combined in ways not specifically recited in this application. In other words, any of the features mentioned in this application may be included in this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

1. A wire-crimping tool, the wire-crimping tool accepts a crimping sleeve having two or more wire members within the crimping sleeve to crimp the crimping sleeve and the two or more wire members together, the wire-crimping tool comprises:
a crimping tool body having one or more lower crimping teeth;
a crimping tool head having one or more upper crimping teeth configured to interlock between the lower crimping teeth to create a plurality of pinch point crimps into the crimping sleeve;
a crimping power source coupled to the crimping tool body and to the crimping tool head to cause the upper and lower crimping teeth to move together when a crimping sleeve and the two or more wire members are in between;
a crimping tool threaded shaft coupled to the crimping tool head, the crimping tool threaded shaft having threads about a lower end that extends out of the crimping tool body; and
a crimping tool nut having matching threads to the crimping tool threaded shaft and being configured to cause the crimping tool threaded shaft to move through the crimping tool nut when rotated, the movement of the crimping tool shaft out of the crimping tool body and through the crimping tool nut causes the crimping tool head and the corresponding upper crimping teeth to move towards the crimping tool body and corresponding lower crimping tool teeth;
wherein the crimping tool nut mates to a socket wrench coupled to a power tool, the power tool reversibly rotates to open and close the space between the crimping tool head with the corresponding upper crimping teeth and the crimping tool body with the corresponding lower crimping tool teeth.

2. (canceled)

3. The wire-crimping tool according to claim 2,
the crimping power source powering the power tool.

4. The wire-crimping tool according to claim 3, wherein the power tool is a drill/impact wrench.

5. The wire-crimping tool according to claim 3, wherein the power tool is a power screwdriver.

6. The wire-crimping tool according to claim 3, wherein the crimping power source is a rechargeable battery coupled to the power tool.

7. The wire-crimping tool according to claim 3, wherein the crimping power source is a power cord coupled to the power tool for connecting the power tool to an AC power source.

8. The wire-crimping tool according to claim 2, wherein the upper crimping teeth and the lower crimping teeth create a single pinch point crimp in the crimping sleeve.

9. The wire-crimping tool according to claim 2, wherein the upper crimping teeth and the lower crimping teeth create two or more pinch point crimp in the crimping sleeve.

10. The wire-crimping tool according to claim 1, wherein the crimping power source is a hydraulic power source.
